(19) United States
(12) Patent Application Publication
(10) Pub. No.: US 2016/0060502 A1
(43) Pub. Date: Mar. 3, 2016

(54) Compositions and Methods for Completing Subterranean Wells

(71) Applicant: SCHLUMBERGER TECHNOLOGY CORPORATION, Sugar Land, TX (US)

(72) Inventor: Slaheddine Kefi, Velizy-Villacoublay (FR)

(73) Assignee: SCHLUMBERGER TECHNOLOGY CORPORATION, Sugar Land, TX (US)

(21) Appl. No.: 14/783,532

(22) PCT Filed: Apr. 9, 2013
(86) PCT No.: PCT/IB2013/001067

§ 371 Date: Oct. 9, 2015

(51) Int. Cl. C09K 8/40

(52) U.S. Cl. CPC C09K 8/40

(57) ABSTRACT

Well treatment compositions comprise at least one cleavable surfactant. The surfactant may be anionic, nonionic or cationic or a combination thereof. When added to spacer fluids, chemical washes or both, the compositions promote the removal of non-aqueous drilling fluids from casing surfaces. Additionally, the treated casing surfaces are water wet, thereby promoting optimal bonding to cement.

### BACKGROUND

The statements in this section merely provide background information related to the present disclosure and may not constitute prior art.

This disclosure relates to compositions and methods for completing subterranean wells, in particular, fluid compositions and methods for completion operations during which the fluid compositions are pumped into a wellbore and make contact with subterranean rock formations.

In the course of completing oil and gas wells and the like, various types of fluids are circulated in the wellbore. These fluids include, but are not limited to, drilling fluids, spacer fluids, cement slurries and gravel-packing fluids. In addition, these fluids typically contain solid particles.

Cement slurries are usually incompatible with most drilling fluids. If the cement slurry and drilling fluid commingle, a highly viscous mass may form that can cause several problems. Cement slurry can channel through the viscous mass. Unacceptably high friction pressures can develop during the cement job. Plugging of the annulus can result in job failure. In all of these situations, zonal isolation may be compromised, and expensive remedial cementing may be required.

Consequently, intermediate fluids called preflushes are often pumped as buffers to prevent contact between cement slurries and drilling fluids. Preflushes can be chemical washes that contain no solids or spacer fluids that contain solids and can be mixed at various densities.

Spacers are preflushes with carefully designed densities and rheological properties. Spacers are more complicated chemically than washes. Viscosifiers are necessary to suspend the solids and control the rheological properties, and usually comprise water-soluble polymers, clays or both. Other chemical components include dispersants, fluid-loss control agents, weighting agents, antifoam agents and surfactants. A thorough discussion concerning the uses and compositions of preflushes may be found in the following publication. Daccord G, Guillot D and Nilsson F: “Mud Removal,” in Nelson E B and Guillot D (eds.): Well Cementing—2^{nd} Edition, Houston: Schlumberger (2006) 183-187. The entire content of the publication, Well Cementing—2^{nd} Edition, is hereby incorporated by reference into the current application.

For optimal fluid displacement, the density of a spacer fluid should usually be higher than that of the drilling fluid and lower than that of the cement slurry. Furthermore, the viscosity of the spacer fluid is usually designed to be higher than the drilling fluid and lower than the cement slurry. The spacer fluid must remain stable throughout the cementing process (i.e., no free-fluid development and no sedimentation of solids). In addition, it may be necessary to control the fluid-loss rate.

Another important function of preflushes is to leave the casing and formation surfaces water wet, thereby promoting optimal bonding with the cement. Achieving water-wet surfaces may be challenging, especially when the drilling fluid has been non-aqueous. Such non-aqueous fluids (NAF) may be oil-base muds or emulsion muds whose external phase is oil-base. For these circumstances, special dispersant and surfactant systems have been developed by the industry. Designing a dispersant/surfactant system for a particular well may be complicated because several parameters must be considered, including the base oil of the NAF, the presence of emulsifiers, the fluid density, bottomhole temperature, presence of brine salts and the chemical nature of the cement system.

### SUMMARY

In an aspect, embodiments relate to well treatment compositions comprising water and at least one cleavable surfactant.

In a further aspect, embodiments relate to methods for treating a subterranean well having at least one casing string, comprising preparing an aqueous spacer fluid, chemical wash or both and adding a well treatment composition to the fluid, wash or both. The composition comprises water and at least one cleavable surfactant. The fluid, wash or both is placed in the well such that the fluid, wash or both flow past the external surface of the casing string.

### DETAILED DESCRIPTION

At the outset, it should be noted that in the development of any such actual embodiment, numerous implementation—specific decisions must be made to achieve the developer's specific goals, such as compliance with system related and business related constraints, which will vary from one implementation to another. Moreover, it will be appreciated that such a development effort might be complex and time consuming but would nevertheless be a routine undertaking for those of ordinary skill in the art having the benefit of this disclosure. In addition, the composition used/disclosed herein can also comprise some components other than those cited. In the summary and this detailed description, each numerical value should be read once as modified by the term “about” (unless already expressly so modified), and then read again as not so modified unless otherwise indicated in context. Also, in the summary and this detailed description, it should be understood that a concentration range listed or described as being useful, suitable, or the like, is intended that any and every concentration within the range, including the end points, is to be considered as having been stated. For example, “a range of from 1 to 10” is to be read as indicating each and every possible number along the continuum between about 1 and about 10. Thus, even if specific data points within the range, or even no data points within the range, are explicitly identified or refer to only a few specific, it is to be understood that inventors appreciate and understand that any and all data points within the range are to be considered to have been specified, and that inventors possessed knowledge of the entire range and all points within the range.

The Applicant has discovered improved compositions and methods for removing NAF drilling fluids from casing surfaces and leaving the surfaces water wet. In addition, the compositions may provide improved environmental suitability and compliance with local environmental regulations.

In an aspect, embodiments relate to well treatment compositions. The compositions comprise water and at least one, cleavable surfactant. The cleavable surfactant concentration may be between 5 wt % and 97 wt %, or may be between 10 and 70 wt %.

The term cleavable surfactant denotes a surfactant having at least one chemical bond within its structure that can be broken when exposed to the temperature and pH conditions encountered during well-cementing operations. Particularly suitable surfactants include those that are no longer surface active after cleavage, and do not produce fragments that could interfere with cement slurry properties (e.g., gelling the slurry, overdispersing the slurry, retarding the set time or accelerating the set time). Such surfactant would therefore have little or no effect on cement slurries should contamination occur.

The surfactant may comprise an anionic surfactant comprising alkyl esters of phosphonates, phosphates or succinates or combinations thereof.

The surfactant may comprise a non-ionic surfactant comprising ethoxylated fatty acid esters, alkyl amides of ethoxylates, ethoxylated dialkyl esters, polyhydric alcohol esters, polyhydric alkylcarbonates, polyhydric alkylcarbamates, polysorbates, alkyl esters of glycerol, alkyl esters of sorbitan, alkyl esters of polyoxyethylene glycol, alkyl esters of polyoxyethylene glycerol, alkyl esters of sorbitan, polyoxyethylene alkylamides, isethionate esters, ethoxylated alkylcarbamates, ethoxylated alkylcarbonates, or combinations thereof, wherein the HLB value is between 9 and 17. The HLB value may be between 10 and 15. The hydrophilic non-ionic surfactant may comprise an alkyl ethoxylate.

The surfactant may comprise a cationic surfactant comprising choline esters or betaine esters or a combination thereof.

The pH of the composition may between 5 and 9, or the pH may be between 6 and 8.

In a further aspect, embodiments relate to methods for treating a subterranean well having at least one casing string, comprising preparing an aqueous spacer fluid, chemical wash or both and adding a well treatment composition to the fluid, wash or both. The composition comprises water and at least one cleavable surfactant. Then the fluid, wash or both containing the composition are placed in the well such that the fluid, wash or both flow past the external surface of the casing string. Details concerning the compositional components and compositional ratios have been discussed previously. The concentration of the composition in the fluid, wash or both may be between 0.25 and 20 wt %, or between 2.5 and 10 wt %.

Although various embodiments have been described with respect to enabling disclosures, it is to be understood that this document is not limited to the disclosed embodiments. Variations and modifications that would occur to one of skill in the art upon reading the specification are also within the scope of the disclosure, which is defined in the appended claims.

1. A well treatment composition, comprising:
i. water; and
ii. at least one cleavable surfactant.

2. The composition of claim 1, wherein the cleavable surfactant comprises an anionic surfactant comprising alkyl esters of phosphonates, phosphates or succinates, or combinations thereof.

3. The composition of claim 1, wherein the cleavable surfactant comprises a non-ionic surfactant comprising ethoxylated fatty acid esters, alkyl amides of ethoxylates, ethoxylated dialkyl esters, polyhydric alcohol esters, polyhydric alkylcarbonates, polyhydric alkylcarbamates, polysorbates, alkyl esters of glycerol, alkyl esters of sorbitan, alkyl esters of polyoxyethylene glycol, alkyl esters of polyoxyethylene glycerol, alkyl esters of sorbitan, polyoxyethylene alkylamides, isethionate esters, ethoxylated alkylcarbamates, ethoxylated alkylcarbonates, or combinations thereof, wherein the HLB value is between 9 and 17.

4. The composition of claim 1, wherein the cleavable surfactant comprises a cationic surfactant comprising choline esters or betaine esters or a combination thereof.

5. The composition of claim 1, wherein the cleavable surfactant concentration is between 5 wt % and 97 wt %.

6. The composition of claim 1, wherein the pH of the composition is between 5 and 9.

7. A method for treating a subterranean well having at least one casing string, comprising:
i. preparing an aqueous spacer fluid, chemical wash or both;
ii. adding a well treatment composition to the fluid, wash or both, the composition comprising:
a. water; and
b. at least one cleavable surfactant; and
iii. placing the fluid, wash or both containing the composition in the well such that the fluid, wash or both flow past the external surface of the casing string.

8. The method of claim 7, wherein the cleavable surfactant concentration in the composition is between 5 wt % and 97 wt %.

9. The method of claim 7, wherein the cleavable surfactant comprises an anionic surfactant comprising alkyl esters of phosphonates, phosphates or succinates or combinations thereof.

10. The method of claim 7, wherein the cleavable surfactant comprises a non-ionic surfactant comprising ethoxylated fatty acid esters, alkyl amides of ethoxylates, ethoxylated dialkyl esters, polyhydric alcohol esters, polyhydric alkylcarbonates, polyhydric alkylcarbamates, polysorbates, alkyl esters of glycerol, alkyl esters of sorbitan, alkyl esters of polyoxyethylene glycol, alkyl esters of polyoxyethylene glycerol, alkyl esters of sorbitan, polyoxyethylene alkylamides, isethionate esters, ethoxylated alkylcarbamates, ethoxylated alkylcarbonates, or combinations thereof, wherein the HLB value is between 9 and 17.

11. The method of claim 7, wherein the cleavable surfactant comprises a cationic surfactant comprising choline esters or betaine esters or a combination thereof.

12. The method of claim 7, wherein the concentration of the composition in the fluid, wash or both is between 0.25 wt % and 20 wt %.

13. The method of claim 7, wherein the well temperature is between 60° C. and 200° C.

14. The method of claim 7, wherein the pH of the composition is between 5 and 9.

15. The method of claim 7, further comprising:
iv. preparing an aqueous cement slurry; and
v. placing the cement slurry in the well.
